(19) United States
(12) Patent Application Publication
(10) Pub. No.: US 2009/0328080 A1
(43) Pub. Date: Dec. 31, 2009

(54) Window Redirection Using Interception of Drawing APIS

(75) Inventors: Radu C. Margarint, Kenmore, WA (US); Karim T. Karouki, Seattle, WA (US); Timothy R. Sullivan, Redmond, WA (US); Gregory D. Swedberg, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/145,988

(22) Filed: Jun. 25, 2008

(51) Int. Cl. G06F 9/44; G06F 9/46

(52) U.S. Cl. 719/329

(57) ABSTRACT

Various embodiments provide an API hooking mechanism to intercept drawing-related calls into a graphics interface, such as a Graphics Device Interface (GDI or GDI+), and redirect the calls to an alternate destination which is different from a destination intended by a calling application. By being aware of when a targeted window for redirection begins and ends drawing, and by being able to control which surfaces the targeted window is actually drawn to, various embodiments can present a compatible interface and control drawing of individual windows in a system on a specific window-by-window level. Redirection can take place at various levels of granularity including on a child window-by-child window basis.

### BACKGROUND

In many software scenarios it can be desirable to be able to show visual contents of a screen area in a container that is different from one intended by the authoring software. An example of such a scenario is in the context of a desktop environment where, for example, one might wish to create a new desktop paradigm that can display renderings from older software that was not created with desktop environments in mind.

One limitation of some classic solutions to the problem of window content redirection has been the intrusiveness accompanying redirection functionality. Specifically, in some approaches, window redirection is handled by the operating system which operates globally in what might be considered as an on/off state—that is, the operating system either redirects all of the windows, or none of the windows. Other solutions operate only on top level windows—which are windows who are parented directly on the desktop, and are not a descended child of another top level window. This limitation does not allow more granular, selective window redirection.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments provide an API hooking mechanism to intercept drawing-related calls into a graphics interface, such as a Graphics Device Interface (GDI or GDI+), and redirect the calls to an alternate destination which is different from a destination intended by a calling application. By being aware of when a targeted window for redirection begins and ends drawing, and by being able to control which surfaces the targeted window is actually drawn to, various embodiments can present a compatible interface and control drawing of individual windows in a system on a specific window-by-window level. Redirection can take place at various levels of granularity including on a child window-by-child window basis.

### BRIEF DESCRIPTION OF THE DRAWINGS

FIG. 1 illustrates an operating environment in which the inventive principles can be employed in accordance with one or more embodiments.

FIG. 2 illustrates an example system in accordance with one or more embodiments.

FIG. 3 is a flow diagram that describes steps in a method in accordance with one or more embodiments.

FIG. 4 illustrates an example computing device 400 that can implement the various embodiments.

### DETAILED DESCRIPTION

Overview

Various embodiments provide an API hooking mechanism to intercept drawing-related calls into a graphics interface, such as a Graphics Device Interface (GDI or GDI+), and redirect the calls to an alternate destination which is different from a destination intended by a calling application. The inventive approach described below can be utilized with any suitable type of graphics framework. To provide context for the reader, the inventive approach is described against the backdrop of GDI interfaces. It is to be appreciated and understood, however, that the inventive approach can be used with other graphics frameworks without departing from the spirit and scope of the claimed subject matter.

GDI is a Microsoft Windows® interface that is utilized to represent graphical objects which can be transmitted to various output devices such as monitors, printers, and the like. GDI, as will be appreciated by the skilled artisan, is utilized to perform tasks such as drawing lines and curves, and rendering other visual components. GDI utilizes what is known as a device context (DC) which is used to define the attributes of text and images that are output to a screen or printer. A DC serves as a handle and is obtained before output is written and released after elements have been written. In operation, a DC is opaque meaning that its data cannot be accessed directly. Rather, a DC can be passed to various GDI functions that will operate on it, either to draw an object, to obtain information about the DC, or change an object in some way.

In the GDI context, at least some embodiments intercept drawing-related calls from an application to an operating system requesting a DC and return a DC different from one that would have been returned by the operating system. The returned DC corresponds to a location or destination to which drawing redirection takes place. Subsequent drawing-related calls then use the returned DC to accomplish drawing-related tasks to draw to a redirection location or destination. In this manner, an application does not know that it is drawing to a destination other than one provided by the operating system. Rather, the application makes its usual calls using the returned DC to effect drawing to the redirection location or destination. In at least some embodiments, the redirected destination comprises an off-screen destination that can be utilized to enable drawn subject matter to be subsequently processed in any suitable way.

By being aware of when a targeted window for redirection begins and ends drawing, and by being able to control which surfaces the targeted window is actually drawn to, various embodiments can present a compatible interface and control drawing of individual windows in a system on a specific window-by-window level. Redirection can take place at various levels of granularity including on a child window-by-child window basis.

In the discussion that follows, a section entitled “Operating Environment” describes but one environment in which the various embodiments can be employed. Following this, a section entitled “Drawing Redirection Example” describes how drawing redirection can take place in accordance with one or more embodiments. Next, a section entitled “Interception of Drawing-Related Calls” describes how drawing-related calls can be intercepted in accordance with one or more embodiments. Following this, a section entitled “Targeted Window Redirection” describes how targeted window redirection can take place in accordance with one or more embodiments. Following this, a section entitled “Maintaining Drawing State” describes how state can be maintained in accordance with one or more embodiments. Next, a section entitled “Example Method” describes an example method in accordance with one or more embodiments. Last, a section entitled “Example System” is provided and describes an example system that can be used to implement one or more embodiments.

Operating Environment

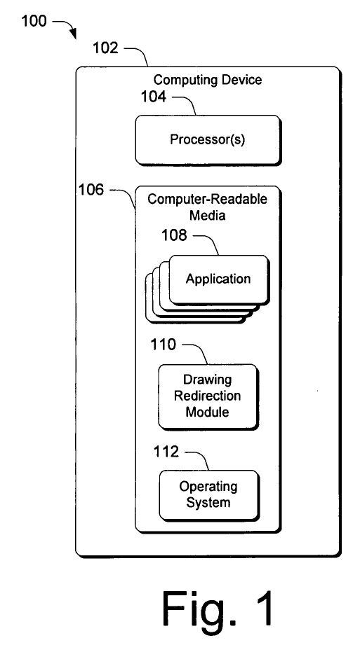

FIG. 1 illustrates an operating environment in accordance with one or more embodiments, generally at 100. Environment 100 includes a computing device 102 having one or more processors 104, one or more computer-readable media 106 and one or more applications 108 that reside on the computer-readable media and which are executable by the processor(s). Applications 108 can include any suitable type of application such as, by way of example and not limitation, applications that are configured to effect drawing of objects, such as windows, in some way.

Environment 100 also includes a drawing redirection module 110 that operates as described above and below. Specifically, drawing redirection module 110 is configured to intercept calls from application 108 to an operating system 112 and return to the calling application a token that is effectively used to redirect drawing-related calls to a destination that is different than a destination associated with a token that would have been returned by operating system 112. In the GDI implementation example described herein, the token returned by drawing redirection module 112 is in the form of a handle to a device context (DC). In other graphics frameworks, the returned token can take a different form without departing from the spirit and scope of the claimed subject matter.

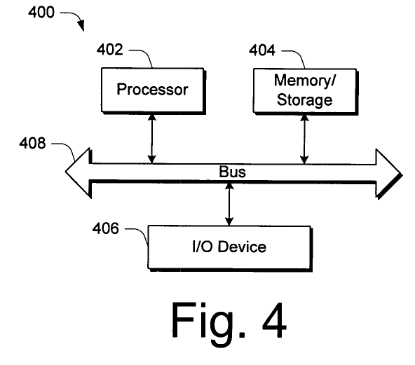

The computer-readable media 106 can include, by way of example and not limitation, all forms of volatile and non-volatile memory and/or storage media that are typically associated with a computing device. Such media can include ROM, RAM, flash memory, hard disk, removable media and the like. One specific example of a computing device is shown and described below in FIG. 4.

Computing device 102 can be embodied as any suitable computing device such as, by way of example and not limitation, a desktop computer, a portable computer, a server, a handheld computer such as a personal digital assistant (PDA), cell phone, and the like.

Having considered an example operating environment, consider now a drawing redirection example in accordance with one or more embodiments.

Drawing Redirection Example

In the discussion that follows, a drawing redirection example is broken down into three separate but related areas: interception of drawing-related calls, targeted window redirection, and maintaining drawing state, each of which is discussed under its own heading below.

Interception of Drawing-Related Calls

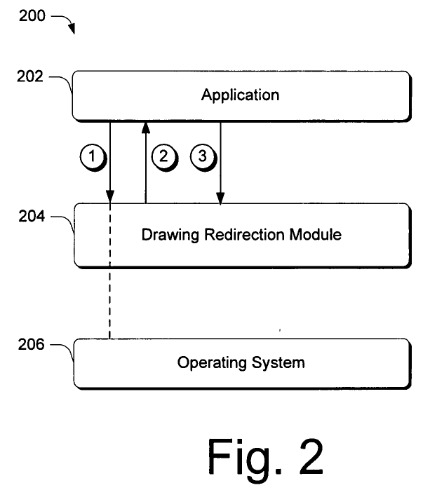

FIG. 2 illustrates an example system in accordance with one or more embodiments generally at 200. System 200 includes an application 202, a drawing redirection module 204, and an operating system 206. In this example, when application 202 wishes to draw a window to a particular location, the application attempts to call operating system 206 to obtain a token that can be used in subsequent drawing-related calls. The token that the application believes it will receive from the operating system 206 is typically used by the operating system to organize and manage drawing-related activities, such as manage state, with respect to the window that the application wishes to draw. As such, application 202 uses the returned token in subsequent drawing-related calls in order to inform the operating system that a particular call pertains to a particular window that the application wishes to draw.

Accordingly, application 202 typically makes an initial call to initiate a window drawing process, indicated by the encircled “1”. Normally, this call would be received by operating system 206 and handled as described above. However, in one or more embodiments, drawing redirection module 204 intercepts the call and returns, as indicated by the encircled “2”, a token which is different from a token that the operating system 206 would have returned had it received the call. The token that is returned by the drawing redirection module 204 is associated with a destination or surface (also termed a location) where drawing activity is to be redirected. In at least some embodiments, the destination or surface is an off-screen destination or surface, such as a memory or disk location.

Once the application has the returned token, it can make its usual drawing-related calls using the token such that drawing activities are redirected to a destination or surface associated with the returned token. During drawing redirection activities, drawing redirection module 204 can keep track of state associated with the redirected window and perform other bookkeeping functions that are described below.

Now, subsequent calls, such as that indicated by the encircled “3”, include a reference to the returned token which, in turn, causes redirection of drawing-related activities.

In the GDI context, the drawing redirection module 204 can be used to intercept calls, including by way of example and not limitation, the following calls on a Win32 platform:

BeginPaint
EndPaint
GetDC
GetWindowDC
GetDCEx
ReleaseDC
IsWindowVisible
GetRandomRgn

The above-described calls constitute entry points for an application to use to obtain destination surface information pertaining to where the application is to draw a particular window. These calls are intercepted as noted above. In the illustrated and described example, the BeginPaint method is a method that returns a token in the form of a device context (DC). It is this call that is initially, in this particular implementation example, intercepted and whose return includes a DC provided by the drawing redirection module 204. Subsequent calls will utilize the provided DC until the EndPaint call is received to terminate the drawing process. The actual drawing calls that application 202 makes will cause drawing to be performed on a destination or surface associated with the returned DC.

Essentially then, calls that are related to the definition or state of the returned DC are intercepted. By intercepting these calls, the drawing redirection module 204 is able to manage and maintain the state of the DC. It is to be noted that in at least some embodiments, the drawing calls themselves are not intercepted. Rather, the calls pertaining to the definition or state of the returned DC are intercepted. The actual drawing calls that the application makes will result in drawing to whatever surface or destination is associated with the returned DC, as noted above. This drawing can be performed by an operating system using whatever token is received with a particular drawing call, e.g., DrawLine( ).

The drawing redirection module can be implemented by any suitably configured drawing redirection module. In at least some embodiments, the drawing redirection module is implemented using a Microsoft-developed technology known as Detours. The Detours technology is described in a paper entitled “Detours: Binary Interception of Win32 Functions”, authored by Galen Hunt and Doug Brubacher and published in Proceedings of the 3^{rd} USENIX Windows NT Symposium, Seattle, Wash., July 1999 and described in U.S. Pat. No. 7,334,235. Briefly, the Detours technology provides a library for instrumenting arbitrary Win32 functions. The Detours technology intercepts Win32 functions by re-writing target function images. The Detours package also contains utilities to attach arbitrary DLLs and data segments, called payloads, to any arbitrary Win32 binary. In operation, Detours replaces the first few instructions of a target function with an unconditional jump to a user-provided detour function. Instructions from the target function are preserved in a trampoline function. The trampoline function includes the instructions removed from the target function and an unconditional branch to the remainder of the target function. The detour function can either replace the target function or extend its semantics by invoking the target function as a subroutine through the trampoline. Additional information on the Detours technology can be found in the references identified above. Of course, other redirection techniques can be employed without departing from the spirit and scope of the claimed subject matter.

Targeted Window Redirection

Targeted window redirection refers to the notion of redirecting, in at least some cases, a single window and not necessarily an entire parent chain of windows. Targeted window redirection provides an ability to redirect windows at a much lower level of granularity than past solutions, at a child window-level and, in some cases, without regard to whether an associated parent window is redirected. In the illustrated and described example, assume that a particular child window of interest is desired to be redirected. Since the BeginPaint method will be called for all windows in the system, in at least some embodiments the drawing redirection module 204 includes a filtering mechanism that is used to identify windows that are desired to be redirected. The filtering mechanism uses a particular property that can be set on a particular window so that the drawing redirection module 204 can identify which windows to redirect. Thus, in at least some embodiments, in order to identify windows of interest, a property is set on the window in the form of a name/value pair. In at least the GDI context, this property is set through an operating system call to SetWindowProp. Now, when BeginPaint gets invoked for a particular window, the drawing redirection module 204 examines this property to see if it exists on that particular window. If the property is set as described above, then redirection occurs by returning a different DC than would have been returned by operating system 206. If, on the other hand, the property is not set, the operating system 206 receives the call and proceeds as it normally would have by, for example, returning its own DC to the application.

Thus, in at least some embodiments, all of the drawing-related calls for all windows come through the drawing redirection module 204. Whether or not the above-identified property is set determines whether redirection occurs. In at least some embodiments, call processing is restricted to calls that are being made within the context of a current process. Calls that are made from other processes are not processed or captured in the manner described above.

In at least some embodiments, and in order to properly execute the drawing of a particular window of interest, certain so-called bookkeeping functions are performed by the drawing redirection module 204. To do so, the particular window of interest is subclassed. Subclassing, as will be appreciated by the skilled artisan, refers to an operating system mechanism that allows third parties to be aware of messages intended for particular windows. These messages may include state information that is useful for maintaining the state and/or context of a redirected window. When a window is subclassed, the drawing redirection module 204 can look for specific messages that are of interest. These messages can include, by way of example and not limitation, paint messages associated with painting, parent notify messages that notify a window that it has a new child window, and destroy and create messages which let a window know that it is being destroyed or created. Thus, subclassing allows the drawing redirection module 204 to maintain bookkeeping state that would normally have been maintained by operating system 206.

Other particular drawing-related nuances can be handled by the drawing redirection module 204 as well. For example, sometimes a parent notify message that would have been used to notify a window that it has a new child window does not fire as intended. In these instances, when a call for a particular window is received, the window is checked to ascertain whether the above-described property is set. If the property is not set, in at least some embodiments, the parent chain of windows is examined by the drawing redirection module 204 to ascertain whether a window in its parent route has this property set. If this property is found to be set in a window in the parent route, then the property is set in the associated child window so that redirection of the child window can occur. That is, in at least some embodiments an assumption is made that if a parent window has its relevant property set, then redirection of associated child windows is likely intended.

Maintaining Drawing State

As noted above, the drawing redirection module 204 has certain bookkeeping functions that are utilized to keep track of and maintain state associated with the drawing process for redirected windows. For example, in at least some embodiments, clipping information can be maintained for redirected windows. Specifically, individual DCs have region information that describe regions in which drawing is to take place and correspondingly, regions where drawing is not take place. This clipping information is maintained as part of the bookkeeping function of the drawing redirection module 204. In addition, the bookkeeping function can also maintain transformation information as well as other information associated with the drawing process.

In addition, the drawing redirection module 204 can use its bookkeeping function in order to simulate the behavior of a system implementation of the APIs that are intercepted. For example, from a window handle it may be desirable to be able to obtain a DC associated with the handle and, from a DC it may be desirable to be able to obtain a window handle associated with it. The operating system would normally keep some type of association list that describes associations between window handles and associated DCs. Since the operating system is not doing the processing for BeginPaint, the drawing redirection module 204 maintains an association list internally that describes associations between window handles and associated DCs. This is done, for among other reasons, so that the drawing redirection model 204 can accurately respond to requests from other APIs that might request information associated with a DC or an associated window handle, as will be appreciated by the skilled artisan. For example, an API call (such as GetRandomRgn( )) may request visibility data from a DC handle. This data, however, is determined by examining a window that is associated with that DC handle.

In addition, in the GDI context when a window has been rendered on a screen or display, the operating system typically keeps track of which areas have been changed, which areas are visible, and which areas are invisible. The operating system uses as information to let the window know when it needs to redraw and in which region it needs to redraw. Again, because the operate system is not handling drawing for a specific redirected window, the drawing redirection module 204 maintains state information associated with such things as visible regions, invisible regions, modified regions, and the like.

Example Method

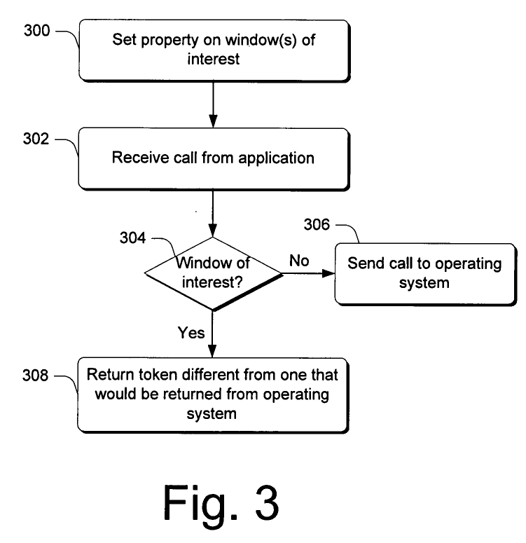

FIG. 3 is a flow diagram that describes steps in a method in accordance with one or more embodiments. The method can be implemented in connection with any suitable hardware, software, firmware or combination thereof. In at least some embodiments, the method can be implemented by a suitably-configured drawing redirection module such as the one described above. It is to be appreciated and understood that the method can be implemented in connection with any suitable drawing or graphics framework, with GDI and GDI+ constituting but one example thereof.

Step 300 sets a property on one or more windows of interest. The property can be set in any suitable way. In at least some embodiments, the property is set via an operating system call an example of which is provided above. Step 302 receives a call from application that desires to draw a window to a particular destination. This call can be any suitable call such as, for example, an initialization call to begin drawing activities. Step 304 ascertains whether a window associated with the call received in step 302 is a window of interest. In at least some embodiments, this step can be performed by ascertaining whether the particular window has an associated property set. If the window is not a window of interest, then step 306 sends the call to an operating system which performs window drawing in accordance with its usual practices. If, on the other hand, step 304 ascertains that the window is a window of interest by, for example, ascertaining that the window has the associated property set, step 308 returns a token to the application that is different from one that would be returned from the operating system. In at least some embodiments, the returned token resides in the form of a device context that is associated with a destination that is different from a destination associated with a device context that would have been returned by the operating system. In at least some embodiments, the returned token is associated with an off-screen destination as described above.

Having returned a token associated with a destination that is different from a token that would have been returned by the operating system, redirection has effectively taken place. Subsequent calls to perform drawing of the associated window can now be made by the application using the returned token which performs drawing to the redirected destination. When drawing is complete, a call to terminate the drawing functions with respect to the redirected window can enable a suitably-configured drawing redirection module to take measures to terminate the redirection.

Having described an example system in which redirection can take place, consider now an example system that can be utilized to implement the embodiments described above.

Example System

FIG. 4 illustrates an example computing device 400 that can implement the various embodiments described above. Computing device 400 can be, for example, computing device 102 of FIG. 1 or any other suitable computing device.

Computing device 400 includes one or more processors or processing units 402, one or more memory and/or storage components 404, one or more input/output (I/O) devices 406, and a bus 408 that allows the various components and devices to communicate with one another. Bus 408 represents one or more of any of several types of bus structures, including a memory bus or memory controller, a peripheral bus, an accelerated graphics port, and a processor or local bus using any of a variety of bus architectures. Bus 408 can include wired and/or wireless buses.

Memory/storage component 404 represents one or more computer storage media. Component 404 can include volatile media (such as random access memory (RAM)) and/or nonvolatile media (such as read only memory (ROM), Flash memory, optical disks, magnetic disks, and so forth). Component 404 can include fixed media (e.g., RAM, ROM, a fixed hard drive, etc.) as well as removable media (e.g., a Flash memory drive, a removable hard drive, an optical disk, and so forth).

One or more input/output devices 406 allow a user to enter commands and information to computing device 400, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media”.

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Conclusion

Various embodiments described above provide an API hooking mechanism to intercept drawing-related calls into a graphics interface, such as a Graphics Device Interface (GDI or GDI+), and redirect the calls to an alternate destination which is different from a destination intended by a calling application. By being aware of when a targeted window for redirection begins and ends drawing, and by being able to control which surfaces the targeted window is actually drawn to, various embodiments can present a compatible interface and control drawing of individual windows in a system on a specific window-by-window level. Redirection can take place at various levels of granularity including on a child window-by-child window basis.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A system comprising:
one or more processors;
one or more computer-readable storage media;
one or more applications embodied on the one or more computer-readable storage media and configured to effect drawing of objects; and
a drawing redirection module embodied on the one or more computer-readable storage media and configured to intercept calls from said one or more applications to an operating system, and return to a calling application a token that is used to redirect drawing-related calls to a destination that is different than a destination associated with a token that would have been returned by the operating system.

2. The system of claim 1, wherein said objects comprise windows.

3. The system of claim 1, wherein said token that is returned to the calling application comprises a device context.

4. The system of claim 1, wherein said calls that are intercepted by said drawing redirection module comprise GDI calls.

5. The system of claim 1, wherein said calls that are intercepted by said drawing redirection module comprise GDI calls, and wherein at least one of the GDI calls intercepted by said drawing redirection module comprises a BeginPaint call.

6. The system of claim 1, wherein the token that is returned to the calling application is associated with an off-screen destination or surface.

7. The system of claim 1, wherein the drawing redirection module is configured to keep track of state associated with drawing redirection.

8. The system of claim 1, wherein the drawing redirection module is configured to intercept calls that constitute entry points for an application to use to obtain destination surface information pertaining to where the application is to draw a particular object.

9. The system of claim 1, wherein the drawing redirection module is configured to intercept said calls using detours functionality.

10. A computer-implemented method comprising:
setting a property on one or more windows of interest;
receiving a call from an application to draw a window to a particular destination;
ascertaining whether a window associated with the call is a window of interest;
responsive to the window associated with the call being a window of interest, returning a token to the application that is different from a token that would have been returned from an operating system receiving the call.

11. The method of claim 10, wherein said setting comprises making an operating system call effective to set the property.

12. The method of claim 10, wherein said ascertaining is performed by ascertaining whether the window associated with the call has an associated property set.

13. The method of claim 10, wherein the token that is returned to the application comprises a device context that is associated with a destination that is different from a destination associated with a device context that would have been returned from the operating system.

14. The method of claim 10, wherein said receiving a call comprises receiving a GDI call.

15. The method of claim 10, wherein said returning a token comprises returning a token associated with an off-screen destination.

16. The method of claim 10, wherein at least one of said one or more windows comprises a child window.

17. The method of claim 10, wherein said one or more windows comprises a single window that does not include a parent window of said single window.

18. The method of claim 10 further comprising subclassing one or more windows of interest.

19. The method of claim 10, wherein said ascertaining further comprises ascertaining whether an additional window in a parent route associated with a window for which drawing is intended is a window of interest and, if so, making said window for which drawing is intended a window of interest.

20. A computer-readable storage medium embodying a drawing redirection module configured to:
intercept GDI window drawing calls, using detours functionality, from an application to an operating system and return, to the application, a device context that is used to redirect GDI window drawing calls to an off-screen destination that is different than a destination associated with a device context that would have been returned by the operating system;
wherein the drawing redirection module is configured to:
keep track of state associated with drawing redirection,
redirect redrawing of child windows without regard to whether an associated parent window is redirected; and
subclass redirected windows of interest.
